(19) United States
(12) Patent Application Publication
(10) Pub. No.: US 2019/0346796 A1
(43) Pub. Date: Nov. 14, 2019

(54) IMAGE FORMING APPARATUS, PROCESSING APPARATUS, IMAGE FORMING SYSTEM, AND IMAGE FORMING METHOD

(71) Applicant: CANON KABUSHIKI KAISHA, Tokyo (JP)

(72) Inventor: Toru Imaizumi, Kawasaki-shi (JP)

(21) Appl. No.: 16/398,903

(22) Filed: Apr. 30, 2019

(30) Foreign Application Priority Data
May 10, 2018 (JP) 2018-091684

(51) Int. Cl. G03G 15/20; G03G 15/00

(52) U.S. Cl. CPC G03G 15/2039; G03G 2215/00067; G03G 15/2064; G03G 15/5004

(57) ABSTRACT

An image forming apparatus, includes: a fixing portion configured to fix a toner image formed according to printing image data on a recording medium; an image processing portion configured to obtain reference image data according to the printing image data and a prescribed image pattern, and determines a target temperature on the basis of the reference image data, the reference image data being used as a reference for determining the target temperature at which the temperature of the fixing portion is maintained; and an electric power control portion configured to control electric power to be supplied to the fixing portion so that the temperature of the fixing portion is maintained at the target temperature.

### BACKGROUND OF THE INVENTION

### Field of the Invention

The present invention relates to an image forming apparatus, a processing apparatus, an image forming system, and an image forming method.

### Description of the Related Art

A film heating type fixing apparatus having a high energy saving characteristic and capable of quickly starting has been known as a conventional fixing apparatus provided in an electrophotographic image forming apparatus such as a laser printer. There has been a technique for controlling the temperature of a fixing apparatus according to a toner laid-on level obtained from image data for the purpose of further energy saving. According to a method disclosed in Japanese Patent Application Publication No. 2008-268784, a print rate is calculated for each of a plurality of regions and appropriate temperature control is carried out according to the result.

### SUMMARY OF THE INVENTION

The temperature necessary for fixing differs depending on how printed images are connected. According to the conventional method for controlling the temperature depending on the print rate for each of a plurality of regions, it may be difficult to address the cases in which images have the same area for printing but are connected differently and the target temperature for fixing must be different between the images. More specifically, when the areas of the images to be printed are the same while the images are connected differently, the target temperature for fixing may not be appropriate.

With the foregoing in view, it is an object of the present invention to control a target temperature for fixing according to the characteristic of images such as how the images are connected.

In order to achieve the object described above, an image forming apparatus including:
a fixing portion configured to fix a toner image formed according to printing image data on a recording medium;
an image processing portion configured to obtain reference image data according to the printing image data and a prescribed image pattern, and determines a target temperature on the basis of the reference image data, the reference image data being used as a reference for determining the target temperature at which the temperature of the fixing portion is maintained; and
an electric power control portion configured to control electric power to be supplied to the fixing portion so that the temperature of the fixing portion is maintained at the target temperature.

In order to achieve the object described above, a processing apparatus configured to cause a fixing portion to fix a toner image formed according to printing image data on a recording medium, including:
an image processing portion configured to obtain reference image data according to the printing image data and a prescribed image pattern, and determines a target temperature on the basis of the reference image data, the reference image data being used as a reference for determining the target temperature at which the temperature of the fixing portion is to be maintained; and
an electric power control portion configured to control electric power to be supplied to the fixing portion so that the temperature of the fixing portion is maintained at the target temperature.

In order to achieve the object described above, an image forming system, including:
a fixing portion configured to fix a toner image formed according to printing image data on a recording medium;
an image processing portion configured to obtain reference image data according to the printing image data and a prescribed image pattern and determines a target temperature on the basis of the reference image data, the reference image data being used as a reference for determining the target temperature at which the temperature of the fixing portion is maintained; and
an electric power control portion configured to control electric power to be supplied to the fixing portion so that the temperature of the fixing portion is maintained at the target temperature.

In order to achieve the object described above, an image forming method for causing a computer to execute:
fixing a toner image formed according to printing image data on a recording medium at a fixing portion;
obtaining reference image data according to the printing image data and a prescribed image pattern, and determining a target temperature on the basis of the reference image data, the reference image data being used as a reference for determining the target temperature at which the temperature of the fixing portion is maintained; and
controlling electric power to be supplied to the fixing portion so that the temperature of the fixing portion is maintained at the target temperature.

According to the present invention, a target temperature for fixing can be controlled according to the characteristic of images such as how the images are connected.

Further features of the present invention will become apparent from the following description of exemplary embodiments with reference to the attached drawings.

### BRIEF DESCRIPTION OF THE DRAWINGS

FIG. 1 is a sectional view of the structure of an image forming apparatus according to a first embodiment of the invention;

FIG. 2A is a diagram illustrating the structure of a printer system according to the first embodiment;

FIG. 2B is a diagram illustrating exemplary functional blocks of an engine control unit according to the first embodiment;

FIG. 3 is a sectional view of the structure of a heat fixing apparatus according to the first embodiment;

FIG. 4 is a diagram illustrating the functional configuration of an image processing unit according to the first embodiment;

FIG. 5A is a flowchart for illustrating processing carried out in determining a target temperature according to the first embodiment;

FIG. 5B is a flowchart for illustrating processing carried out in determining a target temperature according to the first embodiment;

FIGS. 6A to 6C are views for illustrating detection windows according to the first embodiment;

FIGS. 7A to 7D are views for illustrating horizontal line images according to the first embodiment;

FIGS. 8A to 8D are views for illustrating vertical line images according to the first embodiment;

FIGS. 9A and 9B are views for illustrating a text image according to the first embodiment;

FIG. 10 is a view for illustrating area division in image data according to the first embodiment;

FIG. 11 is a chart for illustrating a fixing control sequence based on image analysis according to the first embodiment;

FIGS. 12A and 12B are views for illustrating how toner images having different line widths are each fixed on a recording material;

FIGS. 13A and 13B are views each for illustrating an image pattern according to the first embodiment;

FIG. 14 is a flowchart for illustrating processing carried out in determining a target temperature according to a second embodiment of the invention;

FIGS. 15A and 15B are views each for illustrating a detection window according to the second embodiment;

FIG. 16 is a view for illustrating a result of image processing according to the second embodiment; and

FIGS. 17A and 17B are views for illustrating a result of image processing according to a third embodiment of the invention.

### DESCRIPTION OF THE EMBODIMENTS

Modes for carrying out the invention will be described in detail in conjunction with the accompanying drawings by referring to embodiments of the invention. Note however that the sizes, materials, and shapes of components in the description of the embodiments and their relative positional arrangements should be changed, as appropriate, according to the configuration of an apparatus to which the invention is applied or other various conditions. Therefore, the embodiments are not intended to limit the scope of the present invention.

### First Embodiment

A first embodiment of the present invention will be described.

### Image Forming Apparatus

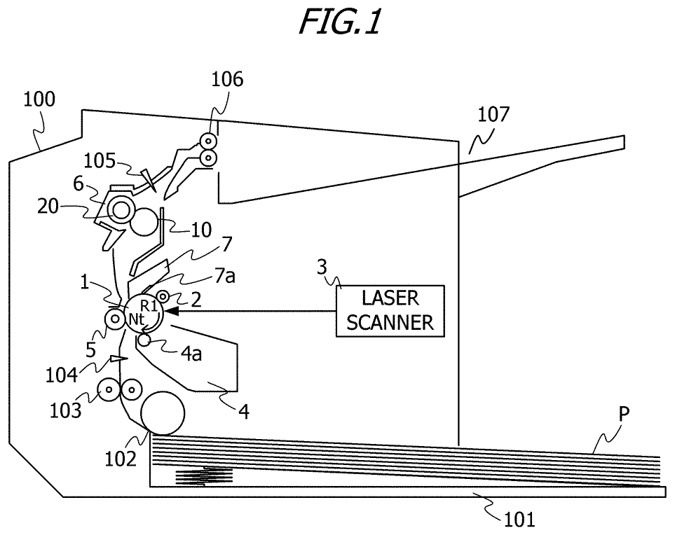

FIG. 1 shows an image forming apparatus according to the first embodiment, i.e., an image forming apparatus including a heat fixing apparatus and image analyzing means according to the first embodiment. Note that FIG. 1 is a vertical sectional view showing a general structure of a monochromatic laser printer as an example of the image forming apparatus according to the first embodiment. With reference to FIG. 1, the structure of the laser printer will be described in detail. Note that the present invention is applicable to various image forming apparatuses using a heat fixing apparatus such as a printer including a laser printer and an LED printer and a digital copier.

The image forming apparatus 100 shown in FIG. 1 includes a drum type electrophotographic photosensitive member (hereinafter as a “photosensitive drum”) 1 as an image carrying member. The photosensitive drum 1 includes a photosensitive material such as an OPC (organic photoconductor), amorphous selenium, and amorphous silicon formed on a drum substrate on a cylinder made of an aluminum alloy or nickel. The photosensitive drum 1 is driven to rotate at a prescribed processing speed (a circumferential speed) in the direction of the arrow R1 by driving means (not shown).

The photosensitive drum 1 is evenly charged to a prescribed polarity/potential by a charging roller 2. The charged photosensitive drum 1 has an electrostatic latent image formed thereon by a laser beam from a laser scanner 3. The laser scanner 3 carries out scanning/exposure controlled to be on/off in response to image information, removes the exposed part of charge, and forms an electrostatic latent image on the surface of the photosensitive drum 1. The electrostatic latent image is developed by a developer 4 and made visible. Toner is made to stick to the electrostatic latent image by a developing roller 4a, so that the image is developed as a toner image. In this way, the toner image is formed on the photosensitive drum 1 according to the image data to be printed. The toner includes substantially spherical particles having a particle size in the range from 4 μm to 10 μm and containing a binder resin, a wax as a release agent, a coloring material, etc. Multiple layers of toner particles are laid on each other at a solid black printing part.

The toner image on the photosensitive drum 1 is transferred onto the surface of a recording material P. The recording material P is an example of a recording medium. The recording material P stored in a paper feed tray 101 is fed on a one-sheet-basis by a feed roller 102 and supplied through conveying rollers 103, etc. to a transfer nip Nt between the photosensitive drum 1 and the transfer roller 5. At the time, the front end of the recording material P is sensed by a top sensor 104, and timing in which the front end of the recording material P reaches the transfer nip Nt is determined on the basis of the position of the top sensor 104, the position of the transfer nip Nt, and the conveying speed for the recording material P. The toner image on the photosensitive drum 1 is transferred onto the recording material P fed and conveyed in the prescribed timing by applying transfer bias on the transfer roller 5.

The recording material P having the toner image transferred thereon is conveyed to a heat fixing apparatus 6. The recording material P is heated and pressurized while the material is nipped by the fixing nip between a film unit 10 and a pressure roller 20 in the heat fixing apparatus 6 and conveyed, so that the toner image is fixed on the surface of the recording material P. The recording material P having the toner image fixed thereon is then discharged by discharge rollers 106 onto a discharge tray 107 formed on the upper surface of the image forming apparatus 100. Note that during this process, a discharge sensor 105 detects the timing in which the front end and rear end of the recording material P pass the sensor and monitors for occurrence of jamming, etc. Meanwhile, in the photosensitive drum 1 after the transfer of the toner image, the toner untransferred onto the recording material P and remaining on the surface (untransferred toner) is removed by the cleaning blade 7a of a cleaning device 7 and used for the next image forming process. The operation described above is repeated and image forming may be successively carried out. Note that the image forming apparatus 100 according to the first embodiment prints 30 sheets/min with a resolution of 600 dpi (LTR longitudinal feed at a speed of about 168 mm/s), and has for example a lifespan of one hundred thousand prints.

Printer Control Device

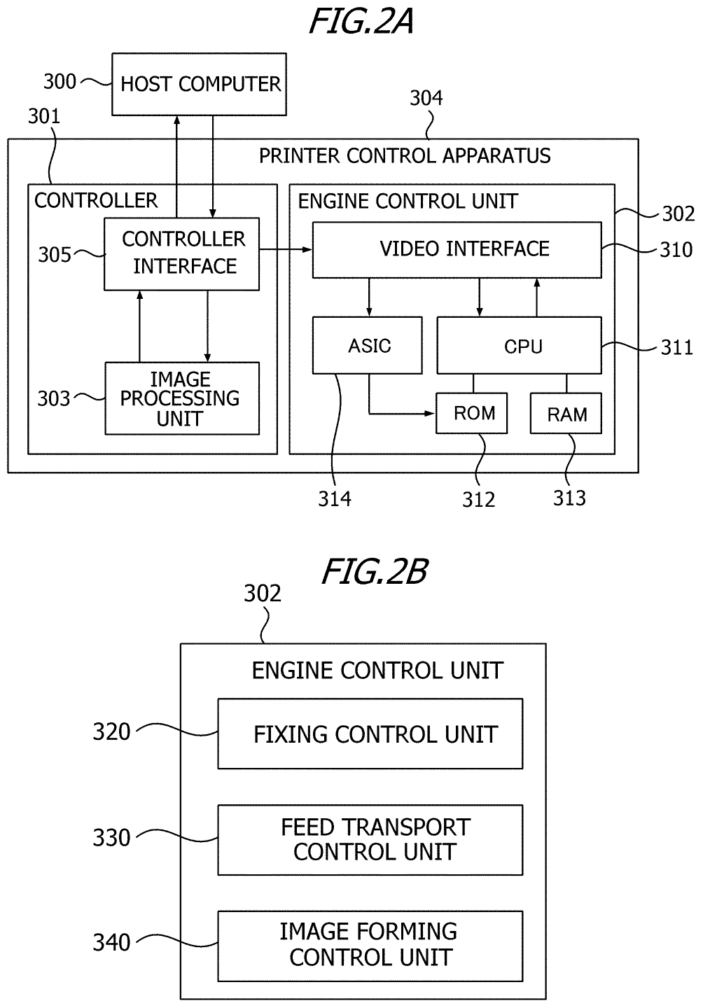

With reference to FIG. 2A, a printer control device 304 according to the first embodiment will be described. The printer control device 304 is incorporated in the image forming apparatus 100 which communicates with a host computer 300. FIG. 2A is a diagram of the structure of a printer system (an image forming system) according to the first embodiment. The host computer 300 may be a server or a personal computer on a network such as the Internet or a local area network (LAN), or a personal digital assistant such as a smart phone or a tablet terminal. The printer control device 304 communicates with the host computer 300 through a controller interface 305. The printer control device 304 is roughly divided into a controller 301 and an engine control unit 302. The controller 301 has an image processing unit 303 and the controller interface 305. The image processing unit 303 carries out processing such as bit mapping to character codes and half-toning to a gray scale image on the basis of information received from the host computer 300 through the controller interface 305. The controller 301 transmits image information to the video interface 310 of the engine control unit 302 through the controller interface 305. The image information includes information for controlling lighting timing for the laser scanner 3, a print mode for controlling process conditions such as a setting temperature and a transfer bias, image size information, and image data to be printed.

The controller 301 transmits information on lighting timing for the laser scanner 3 to an ASIC (Application Specific Integrated Circuit) 314. Meanwhile, the controller 301 transmits information such as a print mode and an image size to a CPU (Central Processing Unit) 311. Note that the controller 301 may transmit the lighting timing information about the laser scanner 3 to the CPU 311. The CPU 311 is also called a processor. The CPU 311 is not limited to a single processor but a multi-processor arrangement may be used. The CPU 311 carries out various kinds of control to the engine control unit 302 using a ROM 312 and a RAM 313. The controller 301 transmits for example a printing instruction and a cancellation instruction to the engine control unit 302 in response to an instruction given by the user on the host computer 300 and controls operation such as the starting and cancellation of printing operation.

FIG. 2B is a diagram for illustrating exemplary functional blocks of the engine control unit 302 according to the first embodiment. As shown in FIG. 2B, the engine control unit 302 has a fixing control unit 320, a feed conveyance control unit 330, and an image forming control unit 340. The CPU 311, as required, stores information in the RAM 313, uses programs stored in the ROM 312 or RAM 313, or refers to information stored in the ROM 312 or the RAM 313. As the CPU 311 carries out these kinds of processing, the engine control unit 302 functions as the portions shown in FIG. 2B. The fixing control unit 320 controls the temperature of the heat fixing apparatus 6. The feed conveyance control unit 330 controls the operation interval of the feed roller 102. The image forming control unit 340 carries out for example process speed control, developing control, charging control, and transfer control. The processing carried out by the image forming apparatus 100 may be partly carried out by the host computer 300 or a server on a network. Part or all of the processing carried out by the engine control unit 302 and the image processing unit 303 may be carried out by the host computer 300 or a server on a network. The host computer 300 and a server on a network are examples of the processing apparatus. Note that part or all of the processing carried out by the engine control unit 302 may be carried out by the image processing unit 303 or part or all of the processing carried out by the image processing unit 303 may be carried out by the engine control unit 302.

Fixing Apparatus

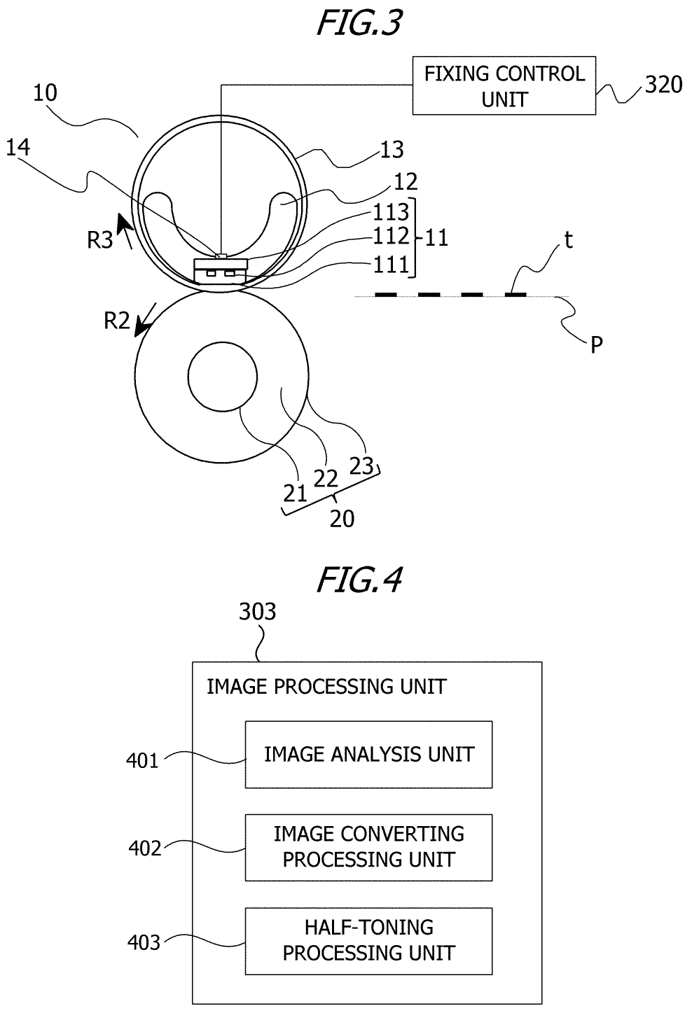

With reference to FIG. 3, the film heating type heat fixing apparatus 6 according to the first embodiment will be described. The heat fixing apparatus 6 includes the film unit 10 as a heating device and the pressure roller 20. The film unit 10 includes a heater 11 as a heating member, a heater holder 12 as a heater holding member, and a fixing film 13 formed as a cylindrical rotating body as a fixing member. The heater 11 is a heating body which uses heat generation caused by conduction of a heat generating body provided on the substrate as will be described. The heat fixing apparatus 6 is provided with the pressure roller (an elastic rotating body) 20 as a pressurizing member opposed to the film unit 10. The heat fixing apparatus 6 having the structure allows the recording material P having a toner image t formed thereon to be conveyed as the material is nipped at the abutting nip (the fixing nip) formed between the heater 11 and the pressure roller 20 through a fixing film 13. In this way, the toner image t is fixed on the recording material P. The heat fixing apparatus 6 is an example of the fixing unit.

As shown in FIG. 3, a temperature sensing member for detecting the temperature of the heater 11 (and the heated region by the heater 11) or a thermistor 14 as a temperature sensing element is provided in abutment on the surface opposite to the sliding surface against the fixing film 13 in the heater 11. The fixing control unit 320 of the engine control unit 302 controls electric power to be supplied to the heater 11 on the basis of the temperature detected by the thermistor 14 so that the temperature of the heater 11 is maintained at a desired temperature. For example, as the fixing control unit 320 controls electric power to be supplied to the heater 11 in response to a signal from the thermistor 14, the temperature of the heater 11 is adjusted. The fixing control unit 320 is an example of a power control unit.

The heater 11 has a resistance heat-generating layer 112 formed on the substrate 113. For the purpose of providing insulation with respect to the resistance heat-generating layer 112 and abrasion resistance, the resistance heat-generating layer 112 is covered with an overcoat glass 111 and the overcoat glass 111 is in contact with the inner peripheral surface of the fixing film 13. A small amount of lubricant such as heat-resisting grease is applied on the surface of the heater 11. This allows the fixing film 13 to rotate smoothly. Alumina is used for the substrate 113 of the heater 11 according to the first embodiment. The substrate 113 for example has a width of 6.0 mm, a length of 260.0 mm, and a thickness of 1.00 mm, and the coefficient of thermal expansion of the substrate 113 is 7.6×10⁻⁶/° C. The resistance heat-generating layer 112 according to the first embodiment is made of a silver-palladium alloy, the total resistance value of the resistance heat-generating layer 112 is for example 20Ω, and the temperature dependence of the resistivity is 700 ppm/° C. The heater 11 is an example of the fixing unit.

The fixing film 13 is a composite laminate film. More specifically, the fixing film 13 has a thin element tube of a metal such as SUS or a substrate produced by kneading a heat resisting resin such as polyimide and a thermally conductive filler such as graphite and forming the kneaded mixture into a tubular shape. Furthermore, the surfaces of the metal element tube and the substrate are coated or tube-covered with a mold release layer such as PFA, PTFE, and FEP directly or through a primer layer. The fixing film 13 according to the first embodiment is a film produced by coating the polyimide substrate with PFA. For example, the total thickness of the fixing film 13 is 70 μm, and the outer peripheral length of the fixing film 13 is 57 mm.

The pressure roller 20 shown in FIG. 3 has a core 21 of iron, etc., an elastic layer 22, and a mold release layer 23. Insulating silicone rubber or heat-resisting rubber such as fluororubber is formed on the core 21 to form the elastic layer 22, and RTV silicone rubber primed to have adhesiveness is applied as an adhesive layer on the elastic layer 22. The mold release layer 23 covered or coated with a tube of PFA, PTFE, or FEP having a conductive agent dispersed therein is formed at the elastic layer 22 through an adhesive layer. According to the first embodiment, for example, the pressure roller 20 has an outer diameter size of 20 mm and a hardness of 48° (Asker-C, under a weight of 600 g). The pressure roller 20 is pressurized from both ends in the longitudinal direction with 15 Kg·f by pressurizing means (not shown) in order to form a nip portion necessary for thermal fixing. The pressure roller 20 is driven to rotate from the longitudinal ends through the core 21 by the rotation driving means (not shown) in the direction of the arrow R2 (anti-clockwise) in FIG. 3. In this way, the fixing film 13 is driven to rotate around the outer side of the heater holder 12 in the direction of the arrow R3 (clockwise) in FIG. 3.

The heater holder 12 holds the heater 11 and is made of a liquid crystal polymer, a phenol resin, PPS, PEEK, etc. The fixing film 13 is fitted to the exterior of the heater holder 12 with an allowance, and the fixing film 13 is rotatably provided. For example, a liquid crystal polymer having heat resistance to 260° C. and a thermal expansion coefficient of 6.4×10⁻⁵/° C. is used for the heater holder 12 according to the first embodiment.

Fixing Control Unit

The engine control unit 302 has a temperature control program. The fixing control unit 320, as a conduction control unit, controls the temperature of the heater 11 at a prescribed temperature on the basis of a detection temperature from the temperature sensing unit or the thermistor 14 as a temperature sensing element. The prescribed temperature is a target temperature (hereinafter as the target temperature) at which the temperature of the heater 11 is maintained. A PID controller using proportional, integral, and derivative terms is preferable as a method for controlling the temperature of the heater 11. The fixing control unit 320 determines heater conduction time within a period by the PID controller, and drives a heater conduction time control circuit (not shown), and determines heater output electric power. According to the first embodiment, the heater output power is updated at every 100 msec as a control period.

The target temperature is determined on the basis of information from the image processing unit 303 which will be described. The fixing control unit 320 may correct the target temperature by various kinds of correction information such as the degree of how much the heat fixing apparatus 6 is warmed, environmental temperature/humidity, a printing mode, and the kind of the recording material P in addition to the information from the image processing unit 303.

Image Processing Unit

FIG. 4 shows a functional configuration of the image processing unit 303. The image processing unit 303 includes an image analysis unit 401, an image converting processing unit 402, and a half-toning processing unit 403. The image analysis unit 401 calculates a target temperature or a correction value necessary for an image to be printed by analyzing the image as will be described. The image converting processing unit 402 subjects character codes to image conversion. The half-toning processing unit 403 subjects a gray-scale image to half-toning processing, etc., and bit-maps the image. For example, in the image forming apparatus 100 according to the first embodiment, processing by the image converting processing unit 402 is carried out with a resolution of 600 dpi. The image processing procedure by the image analysis unit 401 according to the first embodiment will be described. When for example converting processing by the image converting processing unit 402 ends, and before half-toning processing by the half-toning processing unit 403 is carried out, computing processing may be carried out to the image data. Note however that the image processing procedure is not limited to this, and converting processing, half-toning processing, and computing processing may be selected, as appropriate, depending on the image data.

Image Analysis Unit

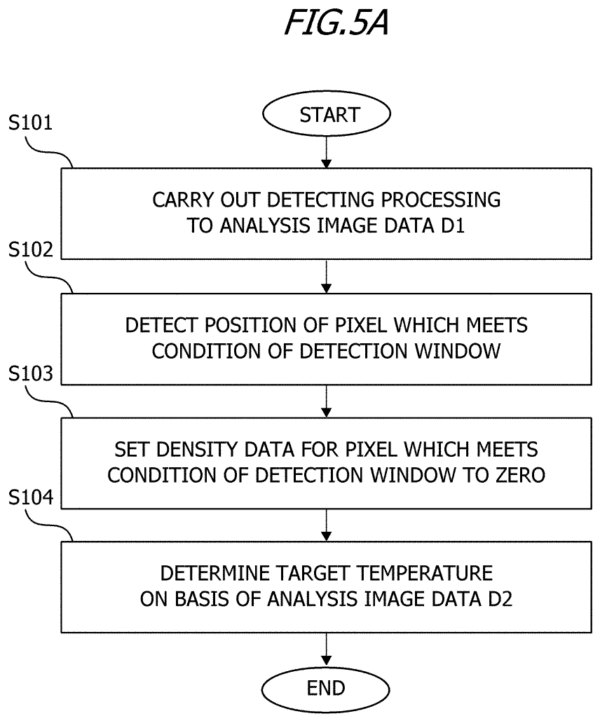

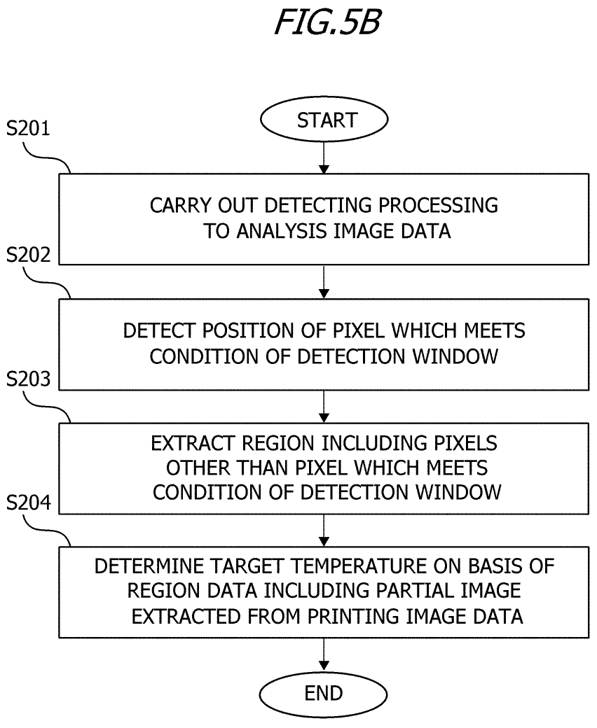

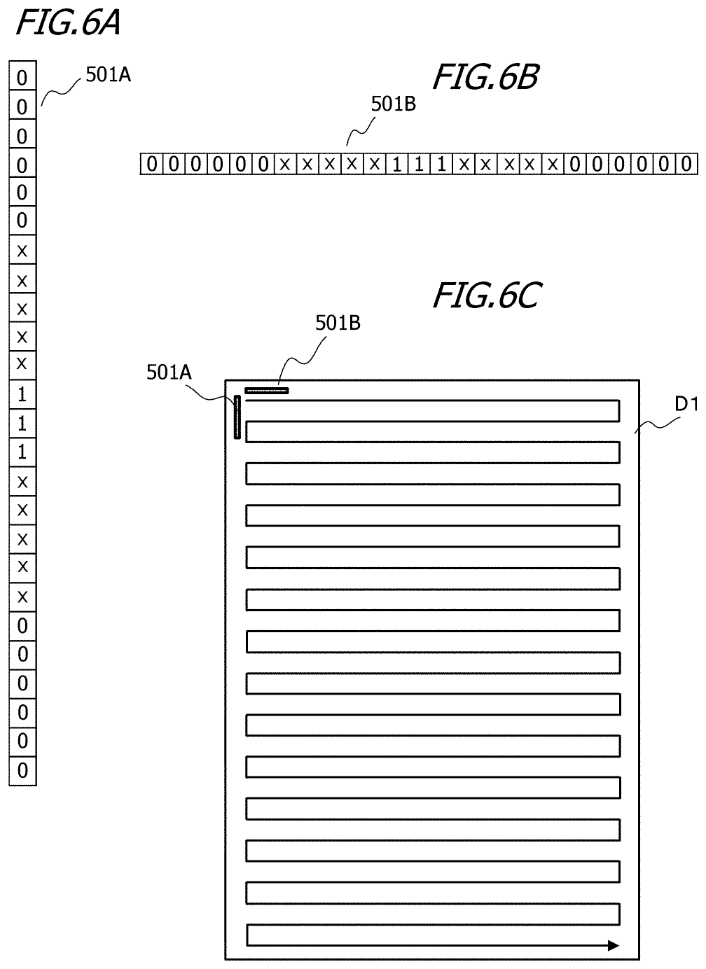

A method for determining a target temperature by the image analysis unit 401 will be described. FIGS. 5A and 5B are flowcharts for illustrating how the image analysis unit 401 determines a target temperature. FIGS. 6A to 6C are schematic views illustrating the detection window and a scanning method with the window illustrated in the flow in FIG. 5A. The processing flow chart in FIG. 5A will be described step by step.

(Step S101)

The image analysis unit 401 produces image data for analysis corresponding to the printing image data (hereinafter as the “analysis image data D1”) on the basis of the image data to be printed (the printing image data) and stores the analysis image data D1 in a memory. The analysis image data D1 is a copy of the printing image data. The image analysis unit 401 carries out detecting processing to the analysis image data D1. The image analysis unit 401 may carry out detecting processing in each of scanning positions by scanning the analysis image data D1 using the detection window 501A shown in FIG. 6A and the detection window 501B shown in FIG. 6B. The image analysis unit 401 may carry out detecting processing in each of scanning positions by scanning the analysis image data D1 using the detection window 501A or 501B. As shown in FIG. 6A, the detection window 501A is a rectangular window which extends in the longitudinal direction of the analysis image data D1. As shown in FIG. 6B, the detection window 501B is a rectangular window which extends in the lateral direction of the analysis image data D1. The lateral direction of the analysis image data D1 is for example a main scanning direction of the analysis image data D1. The main scanning direction of the analysis image data D1 is orthogonal to the conveying direction of the recording material P. The longitudinal direction of the analysis image data D1 is for example a sub scanning direction of the analysis image data D1. The sub scanning direction of the analysis image data D1 is the conveying direction of the recording material P. As for the scanning method, as indicated by the arrow in FIG. 6C, the image analysis unit 401 moves the detection windows 501A and 501B on a one pixel basis in the horizontal or vertical direction with respect to the analysis image data D1, and the entire page of the analysis image data D1 is scanned. In the printing image data and the analysis image data D1, each pixel has density data from 0 to 255. The density data of 255 corresponds to solid black with a print rate of 100%, while density data of 0 corresponds to solid white with a print rate of 0%.

(Step S102)

The image analysis unit 401 detects a pixel which meets a prescribed condition in the process of scanning processing in step S101. The image analysis unit 401 detects the positions (coordinates) of the pixels which meet the prescribed condition in the analysis image data D1 and stores the detected positions of the pixels in the memory. With reference to FIGS. 6A and 6B, the detection windows 501A and 501B will be described. The detection window 501A has a plurality of pixels arranged in the vertical direction. The detection window 501B has a plurality of pixels arranged in the lateral direction. The detection windows 501A and 501B have a length corresponding to 25 pixels. Six pixels represented by “0” at each of the ends of the detection windows 501A and 501B serve as a part for detecting a solid white condition (the density data of 0) in the analysis image data D1. The three pixels represented by “1” in the center part of the detection window 501A or 501B serve as a part for detecting a solid black condition (density data from 230 to 250) in the analysis image data D1. The five pixels represented by “x” between “0” and “1” in each of the detection windows 501A and 501B serve as a part for detecting a solid white condition (density data of 0) or a solid black condition (density data from 230 to 255) in the analysis image data D1. The image analysis unit 401 scans the analysis image data D1 using the detection windows 501A and 501B, and detects pixels which meet a prescribed condition from the analysis image data D1. When the analysis image data D1 is scanned using the detection window 501A, a nondense horizontal line image with a pixel width from 3 to 13 meets the condition of the detection window 501A. Similarly, when the analysis image data D1 is scanned using the scanning window 501B, a nondense vertical line image with a pixel width from 3 to 13 meets the condition of the detection window 501B.

(Step S103)

The image analysis unit 401 sets density data of 0 (the solid white condition) to a location in the analysis image data D1 which meets each of the conditions of the detection windows 501A and 501B. More specifically, the image analysis unit 401 changes the density data for the pixels which meet each of the conditions of the detection windows 501A and 501B. The image analysis unit 401 sets the density data for the pixels which meet each of the conditions of the detection windows 501A and 501B to zero, so that the pixels having the density data set to zero are deleted from the image of the analysis image data D1. For example, the nondense vertical and horizontal lines having a pixel width from 3 to 13 meet the conditions of the detection windows 501A and 501B, and therefore the horizontal line and the vertical line are deleted from the analysis image data D1.

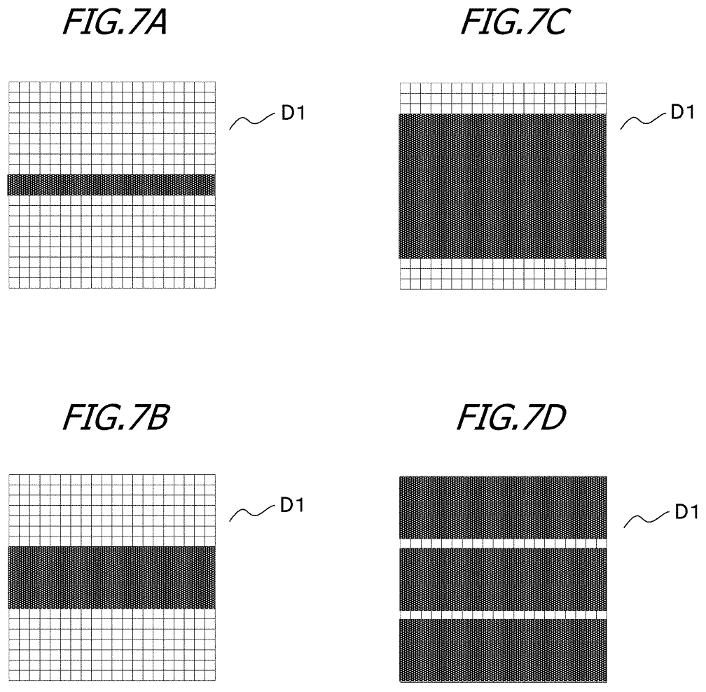

For example, the case of scanning the analysis image data D1 having the horizontal line images shown in FIGS. 7A to 7D using the detection window 501A will be described. The horizontal line images shown in FIGS. 7A to 7D extend in the horizontal direction (in the main scanning direction of the analysis image data DD. The analysis image data D1 shown in FIG. 7A has a horizontal line image of a two-dot line having density data of 255 for each pixel. The horizontal line image in FIG. 7A does not meet the condition of the detection window 501A that the three pixels in the center part are solid black. The analysis image data D1 in FIG. 7B has a horizontal line image of a 6-dot line having density data of 255 for each pixel. The horizontal line image in FIG. 7B meets the condition of the detection window 501A that the three pixels in the center part are solid black, that five pixels on both sides of the center part are solid white or solid black, and that five pixels on both ends are solid white. The analysis image data D1 in FIG. 7C has a horizontal line image of a 14-dot line having density data of 255 for each pixel. The horizontal line image in FIG. 7C does not meet the condition of the detection window 501A that five pixels on both ends are solid white. The analysis image data D1 in FIG. 7D has a horizontal line image in which a six-dot line having density data of 255 for each pixel is repeated at intervals of one dot. When a six-dot line exists in the horizontal line image in FIG. 7D, and a six-dot line is repeated at intervals of one dot, the condition of the detection window 501A that five pixels on both ends are solid white is not met.

The horizontal line images in FIGS. 7A, 7C, and 7D do not meet the condition of the detection window 501A and are not deleted from the analysis image data D1 and left as they are. Meanwhile, the pixels in the horizontal line image in FIG. 7B meets the condition of the detection window 501A. More specifically, the pixels which form the horizontal line image in FIG. 7B meet the condition of the detection window 501A. Therefore, the horizontal image in FIG. 7B is deleted from the analysis image data D1. Note that the analysis image data D1 is used to analyze the image and feedback in determining a target temperature and the actually produced image (printing image) is not deleted.

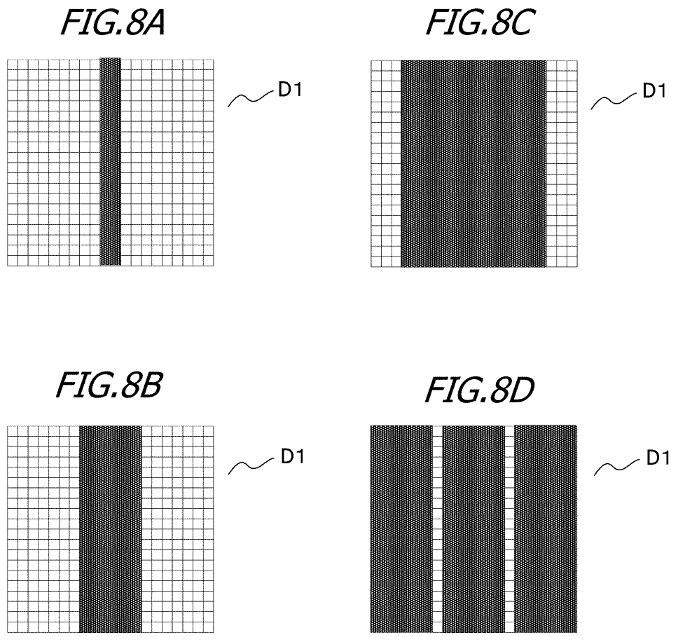

Similarly, the case in which the analysis image data D1 having vertical line images shown in FIGS. 8A to 8D is scanned using the detection window 501B will be described. The vertical line images shown in FIGS. 8A to 8D extend in the vertical direction (in the sub scanning direction of the analysis image data DD. The analysis image data D1 in FIG. 8A has a vertical line image of a two-dot line having density data of 255 for each pixel. The vertical line image in FIG. 8A does not meet the condition of the detection window 501B that three pixels in the center part is solid black. The analysis image data D1 in FIG. 8B has a vertical line image of a six-dot line having density data of 255 for each pixel. The vertical line image in FIG. 8B meets the condition of the detection window 501B that three pixels in the center part is solid black, that five pixels on both sides of the center part are solid white or solid black, and that five pixels on both ends are solid white. The analysis image data D1 in FIG. 8C has a vertical line image of a 14-dot line having density data of 255 for each pixel. The vertical line image in FIG. 8C does not meet the condition of the detection window 501B that five pixels on both ends are solid white. The analysis image data D1 in FIG. 8D has a vertical line image in which a six-dot line having density data of 255 for each pixel is repeated at intervals of one dot. When the six-dot line is present in the vertical line image in FIG. 8D, but the six-dot line is repeated at intervals of one dot, the image does not meet the condition of the detection window 501B that five pixels on both ends are solid white.

The vertical line images in FIGS. 8A, 8C, and 8D do not meet the condition of the detection window 501B, and are not deleted from the analysis image data D1 and left as they are. Meanwhile, the vertical line image in FIG. 8B meets the condition of the detection window 501B. More specifically, the pixels which form the vertical line image in FIG. 8B meet the condition of the detection window 501B. Therefore, the vertical line image in FIG. 8B is deleted from the analysis image data D1. Note that the analysis image data D1 is used to analyze the image and feedback a result for determining a target temperature, and therefore the actually formed image (the printing image) is not deleted.

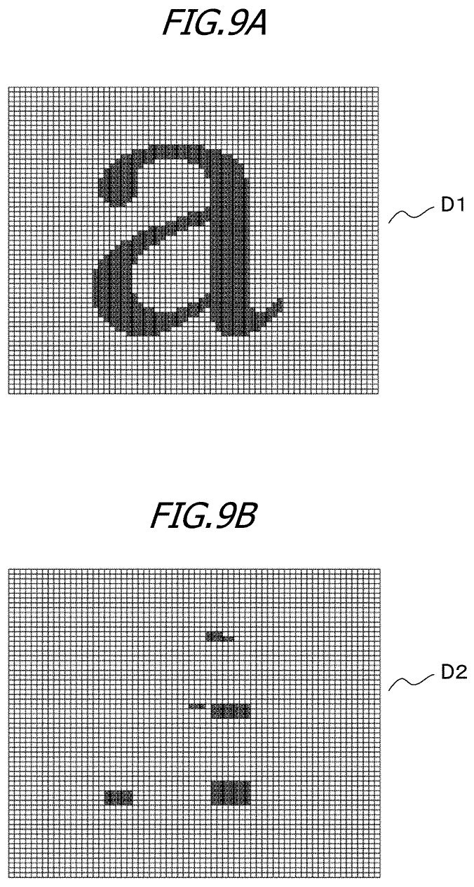

With reference to FIGS. 9A and 9B, the analysis processing by the image analysis unit 401 will be described. FIG. 9A shows analysis image data corresponding to printing image data in a character size of about 10 points. FIG. 9B shows analysis image data D2 obtained by scanning analysis image data D1 using the detection windows 501A and 501B and carrying out image deletion processing. Hereinafter, the analysis image data D1 partly removed will be referred to as analysis image data D2. As shown in FIG. 9B, the processing according to the first embodiment is carried out not only to the line images but also to the text image, an image is partly deleted from the analysis image data D1, and therefore the print rate of the analysis image data D2 decreases.

(Step S104)

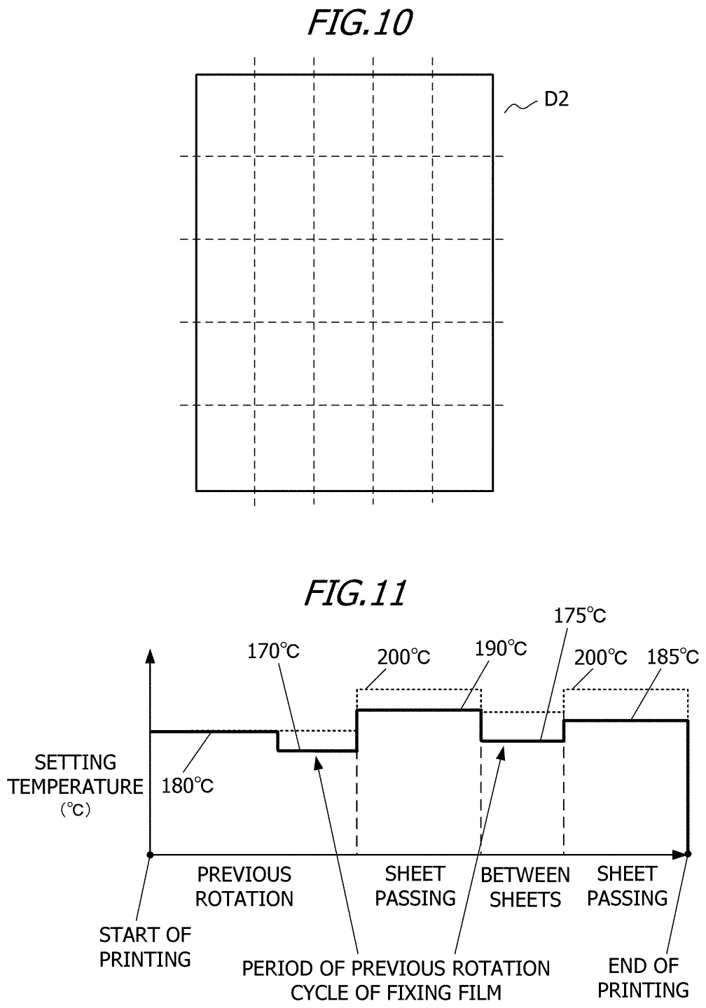

The image analysis unit 401 carries out other kinds of analysis processing using the analysis image data D2. The image analysis unit 401 may carry out the analysis processing according to any conventional method. The image analysis unit 401 determines a target temperature on the basis of the analysis image data D2. The image analysis unit 401 may calculate an average print rate for the analysis image data D2 and determine a target temperature on the basis of the average print rate. The image analysis unit 401 may divide the analysis image data D2 into a plurality of areas, calculate an average print rate for each of the areas, and determine a target temperature on the basis of a maximum value among the print rates. As shown in FIG. 10, according to the first embodiment, the image analysis unit 401 may equally divide the analysis image data D2 in the vertical and horizontal directions and set a plurality of areas in the analysis image data D2. For example, the image analysis unit 401 may divide the analysis image data D2 into 25 areas consisting of five columns and five rows, then calculate an average print rate for each of the areas, and determine a target temperature using a maximum print rate among the entire areas.

Now, the processing flowchart in FIG. 5B will be described step by step.

### (Step S201)

The image analysis unit 401 carries out detecting processing to image data to be printed (printing image data). For example, the image analysis unit 401 carries out detecting processing in each scanning position by scanning the printing image data using the detection windows 501A and 501B. As for the scanning method, the image analysis unit 401 scans the entire page of the printing image data by shifting the detection windows 501A and 501B on a one-pixel basis in the horizontal and vertical directions. The horizontal direction of the printing image data is for example the main scanning direction of the printing image data. The main scanning direction of the printing image data is orthogonal to the conveying direction of the recording material P. The vertical direction of the printing image data is for example the sub scanning direction of the printing image data. The sub scanning direction of the printing image data is the conveying direction of the recording material P.

(Step S202)

The image analysis unit 401 detects pixels which meet a prescribed condition in the process of the scanning processing in step S201. The image analysis unit 401 detects the positions (coordinates) of pixels which meet a prescribed condition in the printing image data and stores the detected positions of the pixels in the memory. The image analysis unit 401 scans the printing image data using the detection windows 501A and 501B and detects the positions of pixels which meet the condition in the printing image data. When the printing image data is scanned using the detection window 501A, a nondense horizontal line image having a pixel width from 3 to 13 meets the condition of the detection window 501A. Similarly, when the printing image data is scanned using the detection window 501B, for example a nondense vertical line image having a pixel width from 3 to 13 meets the condition of the detection window 501B.

(Step S203)

The image analysis unit 401 extracts region data including pixels (hereinafter referred to as “second pixels”) other than the pixels detected in the processing in step S202 (hereinafter referred to as “first pixels”) from the printing image data. In this case, the image analysis unit 401 sets the density data on the first pixel to 0, and the density data on the second pixel in the region data to be equal to the value of the density data on the second pixel in the printing image data. For example, since nondense horizontal and vertical lines having a pixel width from 3 to 13 meet the conditions of the detection windows 501A and 501B, and therefore these vertical and horizontal lines are not included in the region data. Therefore, the region data includes a partial image extracted from the printing image data.

(Step S204)

The image analysis unit 401 carries out other kinds of analysis processing using the region data including the partial image extracted from the printing image data. The image analysis unit 401 may carry out analysis processing according to any conventional method. The image analysis unit 401 determines a target temperature on the basis of the region data including the partial image extracted from the printing image data. The image analysis unit 401 may calculate the average print rate of the region data and determine a target temperature on the basis of the average print rate. The image analysis unit 401 may divide the region data into a plurality of areas, then calculate an average print rate for each of the areas, and determine a target temperature on the basis of a maximum value among the print rates. According to the first embodiment, the image analysis unit 401 may substantially equally divide the region data in the vertical and horizontal directions and set a plurality of areas for the region data. For example, the image analysis unit 401 may divide the region data into 25 areas consisting of five columns and five rows, calculate an average print rate for each of the areas, and determine a target temperature using a maximum print rate among all the areas.

The image analysis unit 401 extracts reference image data to be used as a reference for determining a target temperature from the printing image data. The image analysis unit 401 may produce reference image data on the basis of the printing image data. In steps S101 to S103 described above, the image analysis unit 401 detects pixels which meet a prescribed condition in analysis image data D1 and produces analysis image data D2 by changing the density values (density data) of the pixels which meet the prescribed condition. In steps S201 to S203 described above, the image analysis unit 401 detects pixels which meet a prescribed condition in the printing image data and extracts region data including pixels other than the detected pixels from the printing image data. The image analysis unit 401 may detect pixels which meet a prescribed condition from the printing image data and produce region data including pixels other than the detected pixels on the basis of the printing image data. The image analysis unit 401 determines a target temperature on the basis of reference image data. The image analysis unit 401 determines a target temperature corresponding to the average print rate in the reference image data by referring to the following temperature table, Table 1. The reference image data may include the analysis image data D2 or the region data.

TABLE 1

| Print percentage P (%) | Target temperature T (° C.) |
|---|---|
| 0 ≤ P < 5 | 185 |
| 5 ≤ P < 10 | 190 |
| 10 ≤ P < 50 | 195 |
| 50 < P ≤ 100 | 200 |

According to the first embodiment, in step S104 or S204, the following fixing control is carried out using a target temperature T determined on the basis of the temperature table.

Fixing Control Unit

FIG. 11 is a chart for illustrating a fixing control sequence based on image analysis according to the first embodiment. The dotted line in FIG. 11 indicates a fixing control sequence in a basic setting according to the first embodiment, and the solid line in FIG. 11 indicates a fixing control sequence based on a target temperature determined by the method according to the first embodiment.

When a printing instruction and image data are transmitted from the host computer 300 to the controller interface 305, the image analysis unit 401 determines the target temperature T on the basis of the received image data. Then, the engine control unit 302 starts printing operation in response to a signal from the controller 301. As shown in FIG. 11, at the start of printing operation, the setting temperature (control temperature) for the heater 11 is set to 180° C., and printing operation starts.

Note that when the target temperature T is not determined by the method according to the first embodiment, the temperature of the heater 11 is set to 200° C. in the process of sheet passing. In this case, the temperature control indicated by the dotted line in FIG. 11 is carried out. In the basic setting, the temperature of the heater 11 is changed from 180° C. in the previous rotation to 200° C. in the process of sheet passing, and when the rear end of the recording material P leaves the fixing nip, the temperature is changed to 190° C. for an inter-sheet space, and then raised to 200° C. again when the next recording material P is passed therethrough. The temperature of the heater 11 is controlled in this manner, which allows a toner image to be fixed on the recording material P regardless of an image pattern to be fixed.

A fixing control sequence based on a target temperature determined by the method according to the first embodiment will be described. In the period before the front end of the first recording material P enters the fixing nip (in the period of the previous rotation cycle of the fixing film), the target temperature T determined by the method according to the first embodiment is received, and the setting temperature for the heater 11 is changed. More specifically, the temperature of the heater 11 is controlled on the basis of the target temperature T determined by the method according to the first embodiment. In FIG. 11, the target temperature T for the first recording material P indicated by the solid line is 190° C. If the temperature of the heater 11 is set to 190° C. depending on the timing in which the front end of the recording material P enters the fixing nip, the amount of heat received by the front end of the recording material P from the fixing film 13 which has been warmed by temperature control carried out in the previous rotation may be excessive. Therefore, according to the first embodiment, in the period before the recording material P enters the fixing nip (in the period of the previous rotation cycle of the fixing film), the temperature of the heater 11 is changed from 180° C. to 170° C. The temperature of the heater 11 in the process of sheet passing is set to a target temperature T determined according to the temperature table. More specifically, electric power to be supplied to the heater 11 is controlled so that the temperature of the heater 11 in the process of sheet passing is maintained at the target temperature T.

When the target temperature T corresponding to a toner image to be printed on the second recording material P is 185° C., the setting temperature for the heater 11 is changed from 190° C. to 175° C. after the rear end of the first recording material P leaves the fixing nip. More specifically, in the period before the front end of the second recording sheet P enters the fixing nip (in the period of the previous rotation of the fixing film), the temperature of the heater 11 is set to 175° C. In the sheet passing period of the second recording material P, the temperature of the heater 11 is set to 185° C. Fixing operation ends when the rear end of the second recording material P leaves the fixing nip and there is no following recording material P.

According to the first embodiment, the control described above allows high fixability to be obtained regardless of an image pattern to be processed, while an image forming apparatus 100 which allows unnecessary power consumption to be reduced and provides high energy saving performance can be provided.

Description of Advantageous Effects of First Embodiment

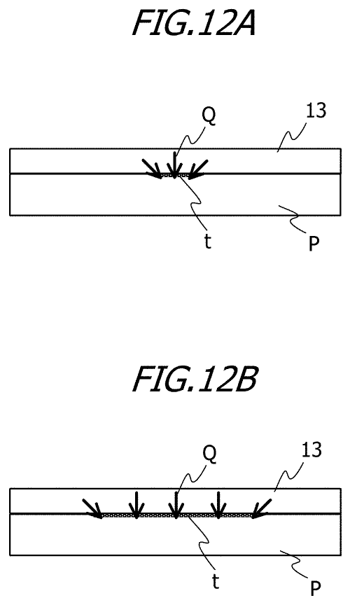

Now, advantageous effects of the first embodiment will be described. The flow of heat in printing a line image with a small line width and a line image with a large line width and fixing the images on a recording material P will be described with reference to FIGS. 12A and 12B. In FIG. 12A, an image with a small line width is formed on a recording material P. In FIG. 12B, an image with a large line width is formed on a recording material P. Since the line width in the image in FIG. 12A is small, a heat flow Q can be received from a part in the vicinity of the region of a printed toner image t on the recording material P. In contrast, since the line width in the image in FIG. 12B is large, the region which can receive a heat flow Q from a part in the vicinity of the region of a printed toner image t on the recording material P is limited. Therefore, the amount of the heat received by the region of the printed toner image t from the fixing film 13 per unit area is greater in FIG. 12A. Therefore, such an image with a small line width as in FIG. 12A has higher fixability. More specifically, the image with the small line width in FIG. 12A may be fixed at a lower temperature.

Note however that when the line width is too small such as the case of a one-dot line, and binding force between toner particles decreases, which may degrade the fixability. In a line image having a line width as small as one dot or two dots has lower fixability. More specifically, there is a line width range which allows the fixability to be improved, and a line image having a line width about in the range from 3 to 13 dots has high fixability. According to the first embodiment, an image having a line width with high fixability is detected by scanning processing using the detection windows 501A and 501B and deleted from analysis image data D1. Also according to the first embodiment, the region data does not include an image having a line width with high fixability. Therefore, a target temperature suitable for each image may be determined according to the first embodiment.

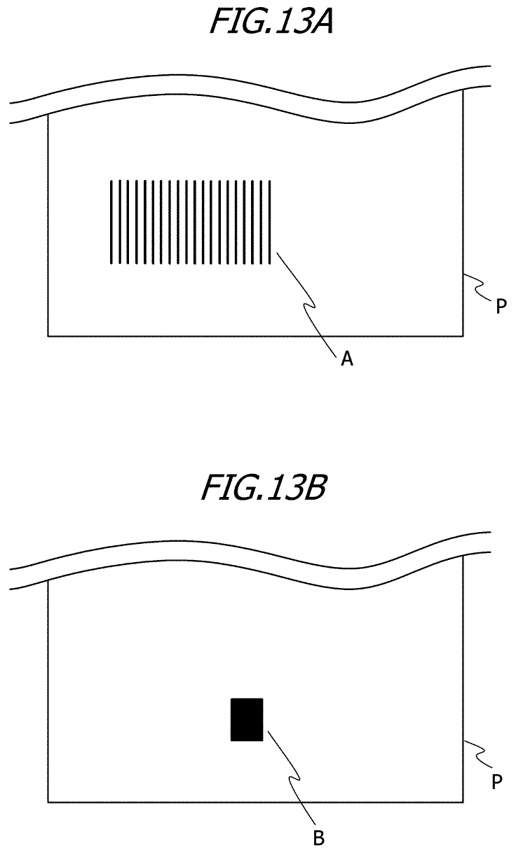

Now, as for two image patterns shown in FIGS. 13A and 13B, a target temperature determined by the method according to the first embodiment and a target temperature determined by a method according to a comparative example will be compared. As shown in FIGS. 13A and 13B, solid black patterns are printed in identical areas in the vicinity of substantially identical locations of the rear ends of recording materials P. The image A shown in FIG. 13A has 15 lines having a width of 0.4 mm and a length of 50 mm at intervals of about 2 mm. The image B shown in FIG. 13B has the same printing area as that of the image A, but is a solid pattern having a width of 15 mm and a length of 20 mm formed in one solid shape. The images A and B are printed while changing the setting temperature for the heater 11, and a result of studying about necessary temperatures for fixing is given in the following Table 2. The target temperature determined by the method according to the first embodiment and the target temperature determined by the method according to the comparative example for the images A and B are given in Table 2. The temperature necessary for fixing the image A is 185° C. and the temperature necessary for fixing the image B is 195° C. The image A can be fixed at a lower temperature than that for the image B because the line pattern of the image A has higher fixability as heat is transmitted around than the solid pattern like the image B.

TABLE 2

| | | Target temperature | |
|---|---|---|---|
| | Temperature necessary | First | |
| Image | for fixing | embodiment | Comparative example |
| A | 185° C. | 185° C. | 195° C. |
| B | 195° C. | 195° C. | 195° C. |

In a comparative example, a target temperature is determined on the basis of a result of calculating an average print rate without conducting scanning processing using the detection windows 501A and 501B according to the first embodiment. More specifically, the average print rate is calculated from analysis image data D1. Since the printing area of the image A and the printing area of the image B are the same, the average print rate of the analysis image data D1 having the image A and the average print rate of the analysis image data D1 having the image B are the same. Therefore, in the comparative example, the target temperature for the image A and the target temperature for the image B are 195° C.

According to the first embodiment, the image A is deleted from the analysis image data D1 by scanning the image A using the detection windows 501A and 501B. Therefore, the average pint percentage of the analysis image data D2 after the image A is deleted from the analysis image data D1 is 0%. According to the first embodiment, when the image B is scanned using the detection windows 501A and 501B, the image B is not deleted from the analysis image data D1. Therefore, according to the first embodiment, the average print rate of the analysis image data D2 having the image B is the same as the average print rate of the analysis image data D1 having the image B in the comparative example. Therefore, according to the first embodiment, the target temperature for the image A is 185° C., and the target temperature for the image A is lower than the target temperature for the image B.

As in the foregoing, according to the first embodiment, an image fixable at a low temperature (such as an image having a line width in a prescribed range) is deleted from the analysis image data D1. As a result, when image data having a text image or a line image having a prescribed width which is fixable at a low temperature is printed, a low target temperature can be set for the heater 11. For example, when a target temperature is set so that an image in a shape or arrangement with the lowest fixability is fixed sufficiently, the target temperature is raised, and excessive power is consumed for a text image or a line image with a prescribed width which are fixable at lower target temperatures and images in other shapes or arrangements. Therefore, the target temperature is set to a high value though the images are fixable at lower temperatures, and this causes unwanted energy consumption. According to the first embodiment, the target temperature for fixing may be controlled according to the characteristics of images such as how images are connected, and therefore the power consumption can be reduced. In this way, the image forming apparatus 100 according to the first embodiment can determine a target temperature appropriate for each image by analyzing images by the described method, and can carry out fixing control appropriate for the image pattern. In this way, the image forming apparatus 100 which provides high fixability and high energy saving performance can be provided.

The target temperature determined by the method according to the first embodiment may be changed on the basis of information on the surrounding environment provided by environment detecting means (not shown) or information provided from a media sensor (recording material kind determining means) which is not shown. In the fixing control according to the first embodiment, only the target temperature is changed, while the gain or offset power amount in a PID controller used for controlling the setting temperature may be changed. In the fixing control according to the first embodiment, the setting temperature for the heater 11 is changed before the toner image on the recording material P enters the fixing nip. In the temperature control according to the first embodiment, the setting temperature for the heater 11 may be changed before the toner image on the recording material P enters the fixing nip or the setting temperature for the heater 11 may be changed in any of the previous stages.

According to the first embodiment, image data for one page may be subjected to image analysis, so that a target temperature for the image data for the page may be determined. Alternatively, according to the first embodiment, image data for one page may be divided into a plurality of regions, and a target temperature may be determined for each of the plurality of regions. In this way, the case of determining a plurality of target temperatures in image data for one page can be addressed.

In the description of the first embodiment, the apparatus is a monochromatic laser beam printer, while the same processing can be carried out in a color laser beam printer. For example in a color laser beam printer for four colors, yellow, magenta, cyan, and black, when a maximum density for each color is 100%, calculation may be based on the sum of density data on yellow, magenta, cyan, and black. More specifically, in the scanning processing using the detection windows 501A and 501B, the condition that locations in which the sum of density data is approximated to 100% is solid black is met. According to the first embodiment, a partial image from the analysis image data D1 is deleted by scanning processing using the detection windows 501A and 501B. Alternatively, data in the location where the condition is satisfied in scanning processing using the detection windows 501A and 501B may be tagged, so that succeeding processing may differ.

An example of the processing by the image analysis unit 401 according to the first embodiment will be described. The image analysis unit 401 scans the analysis image data D1 or the printing image data using at least one of the detection windows 501A and 501B. The image analysis unit 401 detects pixels detected by at least one of the detection windows 501A and 501B in the analysis image data D1 or the printing image data as pixels which meet a prescribed condition. The image analysis unit 401 detects pixels detected by the detection window 501A among pixels which form a horizontal line image extending in the horizontal direction in the analysis image data D1 or the printing image data as pixels which meet a prescribed condition. The image analysis unit 401 detects pixels detected by the detection window 501B among pixels which form a vertical line image extending in the vertical direction in the analysis image data D1 or the printing image data as pixels which meet a prescribed condition.

The image analysis unit 401 produces analysis image data D2 by changing density data for the pixels which meet the prescribed conditions in the analysis image data D1. The analysis image data D2 corresponds to the analysis image data D1 in which the pixels meeting the prescribed conditions have their density data changed. The image analysis unit 401 extracts region data including pixels other than the pixels detected using at least one of the detection windows 501A and 501B from the printing image data. The image analysis unit 401 determines a target temperature on the basis of the analysis image data D2 or the region image data.

### Second Embodiment

A second embodiment of the present invention will be described. In the following description of the second embodiment, pixels which meet a prescribed condition are detected using an oblique detection window. Hereinafter, different features between the first and second embodiments will be described and elements according to the second embodiment identical to those according to the first embodiment are designated by the same reference characters as those of the first embodiment and will not be described.

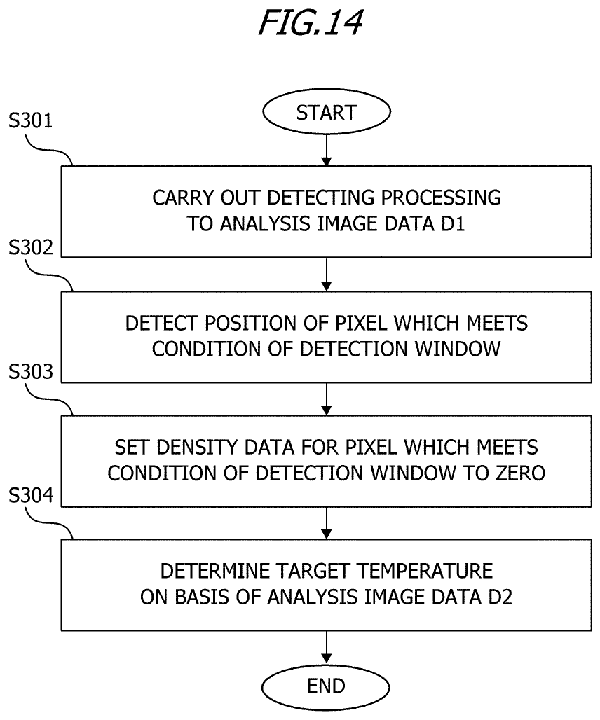

FIG. 14 is a flowchart for illustrating processing carried out by the image analysis unit 401 in determining a target temperature. The processing flowchart in FIG. 14 will be described step by step.

(Step S301)

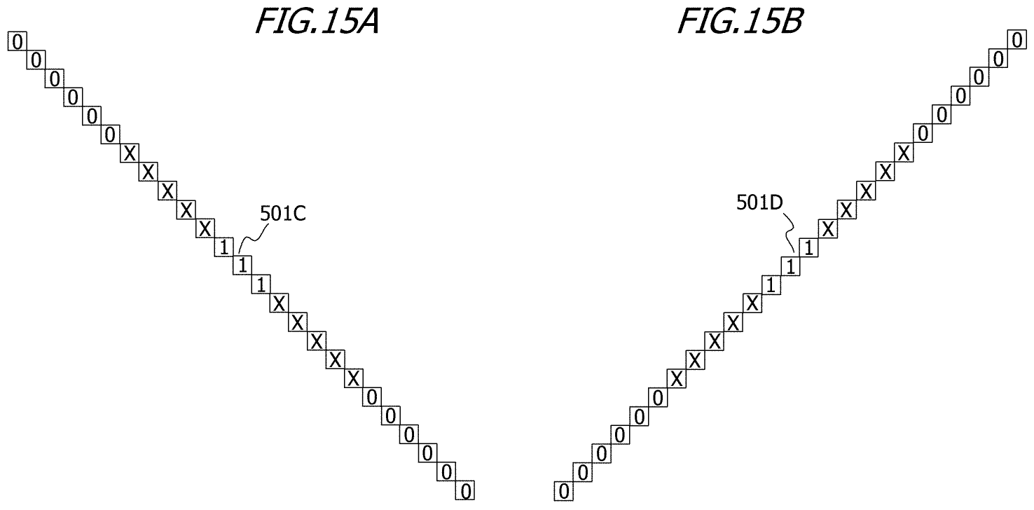

The image analysis unit 401 produces analysis image data D1 on the basis of printing image data and stores the analysis image data D1 in the memory. The analysis image data D1 is a copy of the printing image data. The image analysis unit 401 carries out detecting processing to the analysis image data D1. The image analysis unit 401 may carry out detecting processing to the analysis image data D1 in each of scanning positions by scanning the analysis image data D1 using detection windows 501C and 501D. The image analysis unit 401 may carry out detection processing in each of scanning positions by scanning the analysis image data D1 using the detection window 501C or 501D. The image analysis unit 401 may carry out detecting processing in each of scanning positions by scanning the analysis image data D1 using at least one of detection windows 501A, 501B, 501C, and 501D. As shown in FIG. 15A, the detection window 501C extends in a direction inclined 45° with respect to the horizontal direction. In the example in FIG. 15A, the detection window 501C is inclined from an upper left direction to a lower right direction. A shown in FIG. 15B, the detection window 501D extends in a direction inclined 45° with respect to the horizontal direction. In the example in FIG. 15B, the detection window 501D is inclined from an upper right direction to a lower left direction. As for the scanning method, the image analysis unit 401 scans the entire region of the analysis image data D1 by moving the detection windows 501C and 501D on a one-pixel basis with respect to the analysis image data D1 in the horizontal or vertical direction.

(Step S302)

The image analysis unit 401 detects pixels which meet a prescribed condition in the scanning processing in step S301. The image analysis unit 401 detects the positions (coordinates) of the pixels which meet the prescribed condition in the analysis image data D1 and stores the detected positions of the pixels in the memory. With reference to FIGS. 15A and 15B, the detection windows 501C and 501D will be described. The detection windows 501C and 501D have a plurality of pixels arranged obliquely (inclined 45° with respect to the horizontal direction). The detection windows 501C and 501D have a length corresponding to 25 pixels. Similarly to the detection windows 501A and 501B, six pixels represented by “0” on both ends of each of the detection windows 501C and 501D serve as a part for detecting a solid white condition (in which the density data is zero) in the analysis image data D1. Three pixels represented by “1” in the center part of each of the detection windows 501C and 501D serve as a part for detecting a solid black condition (in which the density data is from 230 to 250) in the analysis image data D1. Five pixels represented by “x” between the “0” and “1” in each of the detection windows 501C and 501D serve as a part for detecting a solid white condition (in which the density data is zero) or a solid black condition (in which the density data from 230 to 255) in the analysis image data D1. The image analysis unit 401 scans the analysis image data D1 using the detection windows 501C and 501D and detects pixels which meet a condition from the analysis image data D1. When the analysis image data D1 is scanned using the detection window 501C, for example a nondense oblique line image having a pixel width from 3 to 13 meets the condition of the detection window 501C. Similarly, when the analysis image data D1 is scanned using the detection window 501D, for example a nondense oblique line image having a pixel width from 3 to 13 meets the condition of the detection window 501D.

(Step S303)

The image analysis unit 401 sets density data to zero (the solid white condition) for the location in the analysis image data D1 which meets the condition of each of the detection windows 501C and 501D. More specifically, the image analysis unit 401 changes the density data for the pixels which meet the conditions of the detection windows 501C and 501D. The image analysis unit 401 sets the density data for the pixels which meet the conditions of the detection windows 501C and 501D to zero, the pixels for which the density data is set to zero are deleted from the image of the analysis image data D1. For example, nondense oblique lines each having a pixel width from 3 to 13 meet the conditions of the detection windows 501C and 501D and therefore these oblique lines are deleted from the analysis image data D1.

(Step S304)

The image analysis unit 401 carries out other kinds of analysis processing using the analysis image data D2 removed of the partial images. Similarly to the first embodiment, the image analysis unit 401 determines a target temperature on the basis of the analysis image data D2.

Similarly to the first embodiment, according to the second embodiment, the image analysis unit 401 may carry out detection processing to printing image data. For example, the image analysis unit 401 scans the printing image data using the detection windows 501C and 501D and carries out detecting processing in each of the scanning positions. The image analysis unit 401 may carry out detecting processing in each of the scanning positions by scanning the printing image data using the detection window 501C or 501D. The image analysis unit 401 may carry out detecting processing in each of scanning positions by scanning the printing image data using at least one of the detection windows 501A, 501B, 501C, and 501D. The image analysis unit 401 carries out the same processing as in the processing flow in FIG. 5B and determines a target temperature on the basis of region data including a partial image extracted from the printing image data.

The image analysis unit 401 extracts reference image data to be used as a reference for determining a target temperature from printing image data. The image analysis unit 401 may produce reference image data on the basis of the printing image data. In steps S301 to S303, the image analysis unit 401 may detect pixels which meet a prescribed condition from analysis image data D1 and produces analysis image data D2 by changing the density value (density data) of the pixels which meet the prescribed condition. Similarly to steps S201 to S203, the image analysis unit 401 detects pixels which meet a prescribed condition from printing image data and extracts region data including the pixels other than the detected pixels from the printing image data. The image analysis unit 401 may also detect pixels which meet a prescribed condition from the printing image data and produce region data including the pixels other than the detected pixels. The image analysis unit 401 determines a target temperature on the basis of the reference image data. With reference to the temperature table in Table 1, the image analysis unit 401 determines a target temperature corresponding to the average print rate in the reference image data similarly to the first embodiment. The reference image data may include the analysis image data D2 or the region data. The fixing control sequence according to the second embodiment is the same as the fixing control sequence according to the first embodiment.

Description of Advantageous Effects of Second Embodiment

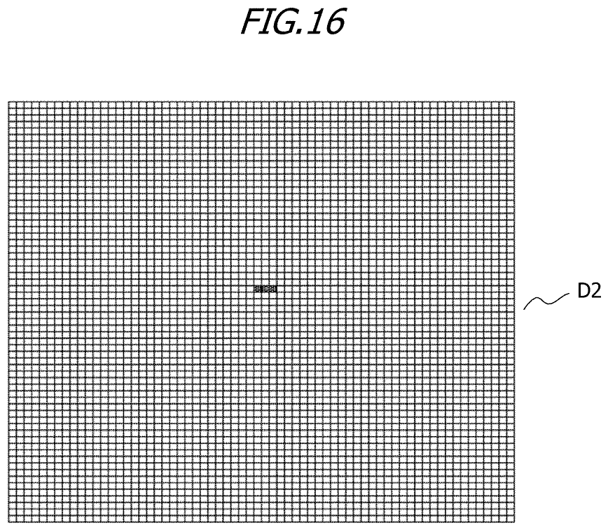

Now, with reference to FIG. 16, advantageous effects brought about by the second embodiment will be described in comparison with FIGS. 9A and 9B illustrating the first embodiment. Note that FIG. 9A illustrates printing image data. FIG. 9B illustrates analysis image data D2 obtained by scanning analysis image data D1 using the detection windows 501A and 501B and then carrying out image deleting processing. FIG. 16 illustrates analysis image data D2 obtained by scanning the analysis image data D1 using the detection windows 501A, 501B, 501C, and 501D and then carrying out image deleting processing.

The analysis image data D1 shown in FIG. 9A is scanned using the detection windows 501A and 501B, followed by image deleting processing, so that mainly vertical and horizontal lines are deleted from the analysis image data D1. In this way, as shown in FIG. 9B, the analysis image data D2 removed of the vertical and horizontal lines is produced. Note however that as shown in FIG. 9B, a crossing part between a vertical line and a horizontal line or a curved part of a line does not meet the conditions of the detection windows 501A and 501B and therefore undeleted parts are left in the analysis image data D1.

The analysis image data D1 shown in FIG. 9A is scanned using the detection windows 501A, 501B, 501C, and 501D, followed by image deleting processing. In this way, a vertical line, a horizontal line, a crossing part between a vertical line and a horizontal line, and a curved part of a line each having a width in a prescribed range are deleted from the analysis image data D1. FIG. 16 illustrates the analysis image data D2 obtained after a vertical line, a horizontal line, a crossing part of horizontal and vertical lines, and a curved part of a line are deleted from the analysis image data D1 in FIG. 9A. The images advantageous in fixability included in the analysis image data D1 in FIG. 9A is almost completely deleted from the analysis image data D1. In this way, using the detection windows 501A in the vertical direction, the detection window 501B in the horizontal direction, and the oblique detection windows 501C and 501D, more images can be removed from the analysis image data D1. The average print rate of the analysis image data D2 in FIG. 16 is lower than the average print rate of the analysis image data D2 in FIG. 9B. The analysis image data D1 is scanned using the detection windows 501A, 501B, 501C, and 501D, followed by image deleting processing, so that printing image data including a text image or a line image having a prescribed width can be fixed at a lower target temperature. According to the second embodiment, a target temperature for fixing may be controlled depending on the characteristic of images such as how the images are connected, and the power consumption can be reduced. According to the second embodiment, an image forming apparatus 100 which has high fixability and provides high energy saving performance can be provided.

An example of processing carried out by the image analysis unit 401 according to the second embodiment will be described. The image analysis unit 401 scans analysis image data D1 or printing image data using at least one of the detection windows 501A, 501B, 501C, and 501D. The image analysis unit 401 detects pixels detected by at least one of the detection windows 501A, 501B, 501C, and 501D as pixels which meet a prescribed condition in the analysis image data D1 or the printing image data. The image analysis unit 401 detects, as pixels which meet a prescribed condition, pixels detected by the detection window 501A among the pixels which form a horizontal line image extending in the horizontal direction in the analysis image data D1 or the printing image data. The image analysis unit 401 detects, as pixels which meets a prescribed condition, pixels detected by the detection window 501B among pixels which form a vertical image extending in the vertical direction in the analysis image data D1 or the printing image data. The image analysis unit 401 detects, as pixels which meet a prescribed condition, pixels detected by the detection window 501C among pixels which form an oblique line image extending in a first oblique direction in the analysis image data D1 or the printing image data. The image analysis unit 401 detects, as pixels which meet a prescribed condition, pixels detected by the detection window 501D among the pixels which form an oblique line image extending in a second oblique direction in the analysis image data D1 or the printing image data. The first and second oblique directions are inclined 45° with respect to the horizontal direction and orthogonal to each other.

The image analysis unit 401 produces analysis image data D2 by changing the density data for pixels which meet a prescribed condition in the analysis image data D1. The analysis image data D2 corresponds to the analysis image data D1 in which the density data for the pixels which meet the prescribed condition has been changed. The image analysis unit 401 extracts region data including pixels other than the pixels detected by at least one of the detection windows 501A, 501B, 501C, and 501D from the printing image data. The image analysis unit 401 determines a target temperature on the basis of the analysis image data D2 or the region image data.

### Third Embodiment

A third embodiment of the present invention will be described. According to the first embodiment, the image analysis unit 401 detects pixels which meet a prescribed condition using the detection window 501A or 501B. According to the second embodiment, the image analysis unit 401 detects pixels which meet a prescribed condition using the detection windows 501A to 501D. According to the third embodiment, the image analysis unit 401 detects pixels which meet a prescribed condition by edge detection. When difference in density data between adjacent pixels is at least prescribed value, an edge corresponds to a pixel having higher density data between the adjacent pixels. According to the third embodiment, the analysis image data D1 is subjected to image processing without using detection windows 501A to 501D according to the first and second embodiments, so that the line image is thinned Hereinafter, different features between the first and second embodiments and the third embodiment will be described, and elements according to the third embodiment identical to those according to the first and second embodiments are designated by the same reference characters as those of the first and second embodiments and will not be described.

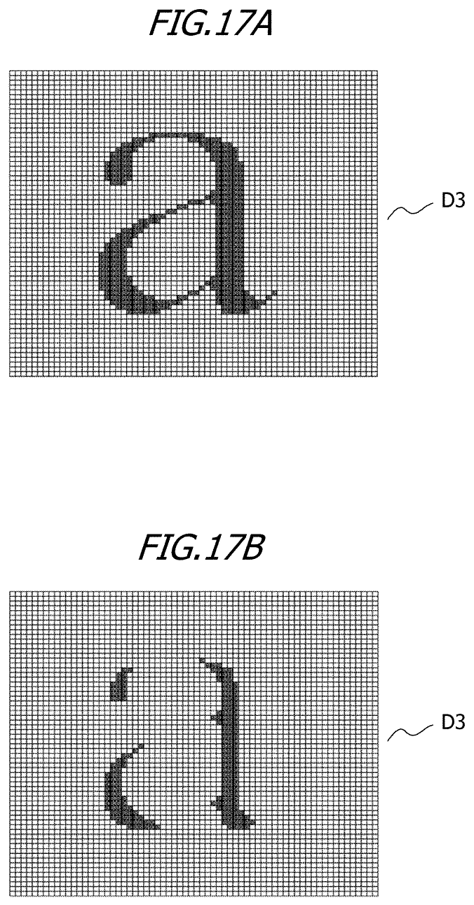

Image processing according to the third embodiment carried out to analysis image data D1 will be described with reference to FIGS. 17A and 17B. FIGS. 17A and 17B illustrate analysis image data D3 obtained after carrying out the image processing according to the third embodiment to the analysis image data D1 shown in FIG. 9A. The analysis image data D3 in FIG. 17A is obtained by carrying out edge detection to the analysis image data D1 in FIG. 9A and changing the density data for pixels detected as edges by the edge detection. In the analysis image data D3 in FIG. 17A, the density data for the pixel detected by the edge detection is set to zero. More specifically, the image analysis unit 401 carries out edge detection to the analysis image data D1 and sets the density data for the pixels detected by the edge detection to zero. Hereinafter, the processing for changing the density data for the pixels detected as edges by the edge detection will be referred to as density changing processing. The analysis image data D3 in FIG. 17B is obtained by carrying out edge detection to the analysis image data D3 in FIG. 17A, and changing the density data for pixels detected as edges. In the analysis image data D3 in FIG. 17B, the density data for pixels detected by the edge detection is set to zero. The analysis image data D3 shown in FIG. 17B is subjected twice to the edge detecting processing and the density changing processing and therefore has a line image thinner than that in the analysis image data D3 shown in FIG. 17A.

In the edge detecting processing and the density changing processing carried out to the analysis image data D1, an edge of a solid black image in a wide range is similarly deleted, while the edge detecting processing and the density changing processing to the analysis image data D1 hardly affects the solid black part in the wide range. In contrast, the edge detecting processing and the density changing processing to the analysis image data D1 greatly affect a text image or a line image. With reference to FIGS. 13A and 13B, advantageous effects of the third embodiment will be described. Since the printing area of the image A in FIG. 13A and the printing area of the image B in FIG. 13B are the same, the average print rate of the analysis image data D1 having the image A and the average print rate of the analysis image data D1 having the image B are the same. Therefore, when the analysis image data D1 having the image A in FIG. 13A is subjected to edge detecting processing and density changing processing, the image A is entirely deleted or has a great area reduction ratio. Meanwhile, when the analysis image data D1 having the image B in FIG. 13B is subjected to edge detecting processing and density changing processing, the reduction ratio of the area of the image B is small. In this way, as the analysis image data D1 is subjected to the edge detecting processing and the density changing processing, fixing can be carried out at lower temperatures to printing image data having a text image or a line image with a prescribed width. According to the third embodiment, an image forming apparatus 100 which has high fixability and provides high energy-saving performance can be provided.

The image analysis unit 401 may average the density data for pixels included in a prescribed region of the analysis image data D1 and may detect pixels having an averaged density data equal to or less than a threshold value as pixels which meet a prescribed condition. The image analysis unit 401 may average density data for pixels included in a prescribed region of the analysis image data D1 and change the density data for pixels having averaged density data equal to or less than a threshold value. More specifically, the image analysis unit 401 may produce analysis image data D3 by setting the density data for pixels having averaged density data equal to or less than a threshold value to zero. In this way, the same advantageous effects as those brought about by the edge detecting processing and the density changing processing to the analysis image data D1 may be provided.

The image analysis unit 401 may carry out edge detection to the printing image data. The image analysis unit 401 may detect pixels detected as edges by the edge detection as pixels which meet a prescribed condition. The image analysis unit 401 extracts, from the printing image data, region data including pixels (hereinafter as the “fourth pixels”) other than the pixels (hereinafter as the “third pixels”) detected as the edges by the edge detection. In this case, the image analysis unit 401 sets the density data for the third pixels in the region data to zero and the density data for the fourth pixels in the region data to the same value as the density data for the fourth pixels in the printing image data.

The image analysis unit 401 may carry out density averaging processing to the printing image data. The image analysis unit 401 may average the density data for pixels included in a prescribed region of the printing image data and detect pixels having averaged density data equal to or lower than a threshold value as pixels which meet a prescribed condition. The image analysis unit 401 extracts, from the printing image data, region data including pixels (hereinafter as the “sixth pixels”) other than the pixels (hereinafter as the “fifth pixels”) having averaged density data equal to or less than the threshold value. In this example, the image analysis unit 401 sets the density data for the fifth pixels in the region data to zero and the density data for the sixth pixels in the region data to the same value as the density data for the sixth pixels in the printing image data.

According to the third embodiment, the target temperature for fixing can be controlled depending on the characteristics of images such as how the images are connected, and therefore the power consumption can be reduced. In this way, the image forming apparatus 100 according to the third embodiment can determine a target temperature appropriate for each image by analyzing images by the described method, and can carry out fixing control appropriate for the image pattern. In this way, the image forming apparatus 100 which provides high fixability and high energy saving performance can be provided.

An example of processing carried out by the image analysis unit 401 according to the third embodiment will be described. The image analysis unit 401 subjects the analysis image data D1 or the printing image data to edge detection. The image analysis unit 401 detects pixels detected as edges in the analysis image data D1 or the printing image data as pixels which meet a prescribed condition. The image analysis unit 401 averages the density data for pixels included in a prescribed region of the analysis image data D1 or the printing image data. The image analysis unit 401 detects pixels included in the prescribed region as pixels which meet a prescribed condition when the averaged density data for the pixels included in the prescribed region is not more than a threshold value.

The image analysis unit 401 produces analysis image data D3 by changing the density data for the pixels which meet a prescribed condition in the analysis image data D1. The analysis image data D3 corresponds to the analysis image data D1 in which the density data for the pixels which meet the prescribed condition has been changed. The image analysis unit 401 extracts, from the printing image data, region data including the pixels other than the pixels which meets the prescribed condition in the printing image data. The image analysis unit 401 determines a target temperature on the basis of the analysis image data D3 or the region image data.

Embodiments of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-091684, filed on May 10, 2018, which is hereby incorporated by reference herein in its entirety.

What is claimed is:

1. An image forming apparatus, comprising:
a fixing portion configured to fix a toner image formed according to printing image data on a recording medium;
an image processing portion configured to obtain reference image data according to the printing image data and a prescribed image pattern, and determines a target temperature on the basis of the reference image data, the reference image data being used as a reference for determining the target temperature at which the temperature of the fixing portion is maintained; and
an electric power control portion configured to control electric power to be supplied to the fixing portion so that the temperature of the fixing portion is maintained at the target temperature.

2. The image forming apparatus according to claim 1,
wherein the image processing portion detects pixels which meet a prescribed condition from the printing image data and extracts region data including pixels other than the detected pixels from the printing image data, and
wherein the reference data includes the region data.

3. An image forming apparatus according to claim 2,
wherein the image processing portion scans the printing image data using at least one detection window, and detects pixels detected by the at least one detection window as the pixels which meet the prescribed condition.

4. The image forming apparatus according to claim 2,
wherein the image processing portion scans the printing image data using the at least one detection window, and detects, as the pixels which meet the prescribed condition, pixels detected by the at least one detection window among pixels which form a line image extending in at least one of a main scanning direction orthogonal to a conveying direction of the recording medium, a sub scanning direction which coincides with the conveying direction of the recording medium, and directions inclined 45° with respect to the main scanning direction.

5. The image forming apparatus according to claim 2,
wherein the image processing portion detects edges from the printing image data, and detects pixels detected as the edges as the pixel which meet the prescribed condition.

6. The image forming apparatus according to claim 2,
wherein the image processing portion averages density values for pixels included in a prescribed region of the printing image data and detects pixels having averaged density values which are at most equal to a threshold value as the pixels which meet the prescribed condition.

7. The image forming apparatus according to claim 1,
wherein the image processing portion detects pixels which meet the prescribed condition from analysis image data corresponding to the printing image data and changes density values for the pixels which meet the prescribed condition, and
wherein the reference image data includes the analysis image data in which the density values for the pixels which meets the prescribed condition has been changed.

8. The image forming apparatus according to claim 7,
wherein the image processing portion scans the analysis image data using at least one detection window and detects pixels detected by the at least one detection window as the pixels which meet the prescribed condition.

9. The image forming apparatus according to claim 7,
wherein the image processing portion scans the analysis image data using the at least one detection window, and detects, as the pixels which meet the prescribed condition, pixels detected by the at least one detection window among pixels which form a line image extending in at least one of a main scanning direction orthogonal to a conveying direction of the recording medium, a sub scanning direction which coincides with the conveying direction of the recording medium, and directions inclined 45° with respect to the main scanning direction.

10. The image forming apparatus according to claim 7,
wherein the image processing portion detects edges from the analysis image data and detects pixels detected as the edges as a pixel which meets the prescribed condition.

11. The image forming apparatus according to claim 7,
wherein the image processing portion averages density values for pixels included in a prescribed region of the analysis image data and detects pixels having averaged density values which are at most equal to a threshold value as the pixels which meet the prescribed condition.

12. The image forming apparatus according to claim 7,
wherein the analysis image data is a copy of the printing image data.

13. A processing apparatus configured to cause a fixing portion to fix a toner image formed according to printing image data on a recording medium, comprising:
an image processing portion configured to obtain reference image data according to the printing image data and a prescribed image pattern, and determines a target temperature on the basis of the reference image data, the reference image data being used as a reference for determining the target temperature at which the temperature of the fixing portion is to be maintained; and
an electric power control portion configured to control electric power to be supplied to the fixing portion so that the temperature of the fixing portion is maintained at the target temperature.

14. An image forming system, comprising:
a fixing portion configured to fix a toner image formed according to printing image data on a recording medium;
an image processing portion configured to obtain reference image data according to the printing image data and a prescribed image pattern and determines a target temperature on the basis of the reference image data, the reference image data being used as a reference for determining the target temperature at which the temperature of the fixing portion is maintained; and
an electric power control portion configured to control electric power to be supplied to the fixing portion so that the temperature of the fixing portion is maintained at the target temperature.

15. An image forming method for causing a computer to execute:
fixing a toner image formed according to printing image data on a recording medium at a fixing portion;
obtaining reference image data according to the printing image data and a prescribed image pattern, and determining a target temperature on the basis of the reference image data, the reference image data being used as a reference for determining the target temperature at which the temperature of the fixing portion is maintained; and
controlling electric power to be supplied to the fixing portion so that the temperature of the fixing portion is maintained at the target temperature.
